(19) United States
(12) Patent Application Publication
(10) Pub. No.: US 2015/0309279 A1
(43) Pub. Date: Oct. 29, 2015

(54) ASSEMBLIES WITH FIBER OPTIC ADAPTER PANELS HAVING AIR FLOW PROVISIONS

(71) Applicant: CORNING OPTICAL COMMUNICATIONS LLC, Hickory, NC (US)

(72) Inventors: Micah Colen Isenhour, Lincolnton, NC (US); Dennis Michael Knecht, Hickory, NC (US); James Phillip Luther, Hickory, NC (US); Timothy James Orsley, San Jose, CA (US)

(73) Assignee: CORNING OPTICAL COMMUNICATIONS LLC, Hickory, NC (US)

(21) Appl. No.: 14/280,965

(22) Filed: May 19, 2014

Related U.S. Application Data
(60) Provisional application No. 61/826,626, filed on May 23, 2013.

(51) Int. Cl. G02B 6/44; G02B 6/38

(52) U.S. Cl. CPC G02B 6/4453; G02B 6/3825; G02B 6/4452; G02B 6/3885

(57) ABSTRACT

A fiber optic adapter panel for connecting optical fibers, and mountable to a housing includes a front face and a rear face. An adapter region includes a plurality of adapters extending between the front face and the rear face. A ventilation region has one or more openings through the adapter panel extending between the front face and the rear face, such that air passes through the one or more openings and into the housing.

### RELATED APPLICATION

This application claims the benefit of priority under 35 U.S.C. §119 of U.S. Provisional Application No. 61/826,626 filed May 23, 2013, the content of which is relied upon and incorporated herein by reference in its entirety.

### BACKGROUND

1. Field of the Disclosure

The disclosure relates generally to connector assemblies for connecting optical fibers, and more particularly, to connector assemblies with air flow provisions.

2. Technical Background

Typical optical telecommunication systems and networks include one or more telecommunications data centers that provide large numbers of optical and electrical cable connections that join various types of network equipment. The typical system also includes a number of outlying stations that extend the system into a network. Examples of network equipment include electrically-powered (active) units such as optical line terminals (OLTs), optical network terminals (ONTs), network interface devices (NIDs), servers, splitters, combiners, multiplexers, switches and routers, fanout boxes and patch panels. This network equipment is often installed within cabinets in standard-sized equipment racks. Each piece of equipment typically provides one or more adapters where optical or electrical patch cables (“jumper cables”) can be physically connected to the equipment. These patch cables are generally routed to other network equipment located in the same cabinet or in another cabinet.

A common problem in telecommunications systems, and in particular with optical telecommunications equipment, is space management. Current practice in telecommunications is to utilize standard electronics racks or frames that support standards-sized stationary rack-mounted housings of various widths. Vertical spacing has been divided into rack units “U”, where 1 U=1.75 inches. The housings may be fixed, slide-out, or swing-out patch/splice panels or shelves. However, the configurations and sizes of present-day housings for optical telecommunications equipment have been defined largely by the properties of the fiber optic cables that connect to the devices supported by the housings. In particular, the configurations and sizes have been established based on the particular ability of the fiber optic cables and optical fibers therein to interface with the devices without exceeding the bending tolerance of the fiber optic cable and the optical fibers. This has resulted in telecommunications equipment that occupies relatively large amounts of space, and in particular a relatively large amount of floor space in a central office or data center. It has also led to data center patch panels being increasingly overpopulated due to connector and cable volumes.

### SUMMARY

One embodiment of the disclosure relates to a fiber optic adapter panel for connecting optical fibers, and mountable to a housing. The fiber optic adapter includes a front face and a rear face. An adapter region includes a plurality of adapters extending between the front face and the rear face. A ventilation region has one or more openings through the adapter panel extending between the front face and the rear face, such that air passes through the one or more openings and into the housing.

In another embodiment, a connector assembly for connecting optical fibers includes a box-like housing structure adapted to mount in an equipment rack. A fiber optic adapter is provided panel for connecting optical fibers mounted to the housing structure. The adapter panel includes a front face and a rear face. An adapter region includes a plurality of adapters extending between the front face and the rear face. A ventilation region has one or more openings through the adapter panel extending between the front face and the rear face, such that air passes through the one or more openings and into the housing.

In another embodiment, a fiber optic adapter panel for connecting optical fibers, and mountable to a housing includes a front face, a rear face and sides that extend lengthwise between the front and rear faces. A row of adapters extends between the front and rear faces with at least one row opening located between adjacent adapters of the row of adapters and extending between the front and rear faces such that air passes through the at least one row opening and into the housing.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a connector assembly having fiber optic adapter panels according to one or more embodiments shown and described herein;

FIG. 2 illustrates a fiber optic adapter panel for use with the connector assembly of FIG. 1;

FIG. 3 is a perspective view of the fiber optic adapter panel of FIG. 2 according to one or more embodiments shown and described herein; and

FIG. 4 is a front view of the fiber optic adapter panel of FIG. 2 showing its air flow openings.

### DETAILED DESCRIPTION

Embodiments described herein generally relate to high-density multi-fiber assemblies that are used to receive and house a plurality of multi-fiber optical connectors (e.g., MTP based connectivity) to establish and maintain connections therewith. An array or set of tightly packed adapters as part of a fiber optic adapter panel provide individual connector-adapter-connector locations that provide a relatively high density of connector/adapter pairs in a housing structure adapted to be mounted in a 1-U or 2-U space of an equipment rack. Between adjacent adapters, ventilation openings are provided. As will be described in greater detail below, the ventilation openings allow air to pass from outside the housing structure into the housing structure at locations between the adapters for mitigating heat build-up within the housing structure.

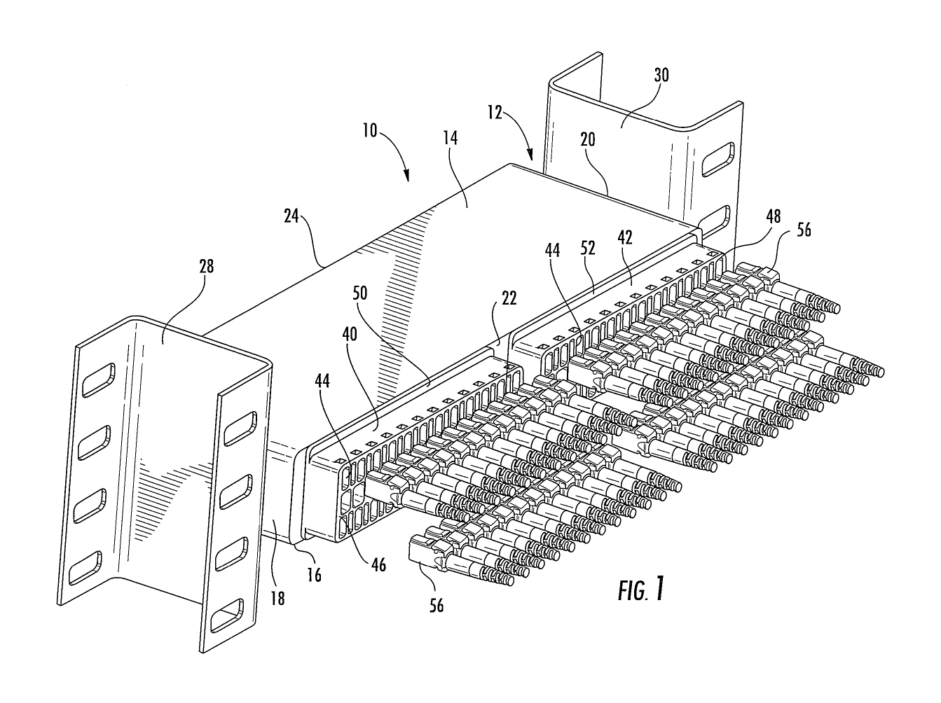

Referring to FIG. 1, a multi-fiber adapter housing 10 includes a housing structure 12 having a front face 22, a rear face 24, a top wall 14, a bottom wall 16 and side walls 18 and 20 that extend between the front and rear faces 22 and 24 of the housing structure 12. The housing structure 12 may have one or more moveable panels, doors or other opening features for providing access to the interior of the housing structure 12. With the housing structure assembled, any U-sized sized housing structure 12 may be provided, as non-limiting examples, 1-U or 2-U sized housing structure, adapted to be mounted in a 1 or 2-U space of an equipment rack (e.g., using rack mount structures 28 and 30). A “U” space as referred to herein has an internal width W of no more than 17.75 inches and an internal height H of no more than 1.75 inches. Thus, a 2-U space, as used herein, refers to a space having an internal height H of no more than 3.50 inches for the given internal width W of 17.75 inches.

Fiber optic adapter panels 40 and 42 have front faces 46 and 48 that are exposed from outside the housing structure 12 at its front face 22. The fiber optic adapter panels 40 and 42 may be connected to the housing structure 12 in any suitable fashion. For example, in the illustrated embodiment, flanges 50 and 52 may be provided that allow that fiber optic adapter panels 40 and 42 to be fastened or otherwise connected to the front face 22 of the housing structure 12. As a non-limiting example, one or both of the housing structure 12 and adapter panel 40 may provide for a slotted fastening structure with end fastening or top/bottom fastening. Fastening may be done by screws or any other suitable fastener. As shown, two fiber optic adapter panels 40 and 42 are provided. In other embodiments, more or less than two fiber optic adapter panels may be used, such as one or three or more fiber optic adapter panels.

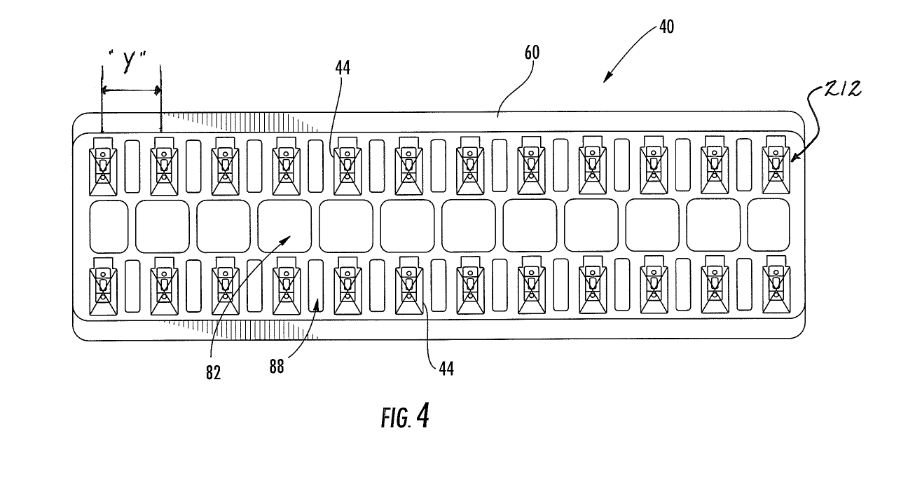

Adapters 44 provide individual connector-adapter-connector locations that provide a relatively high density of connector pairs in the housing structure 12. The adapters 44 may receive any suitable connector type, such as multi-fiber connectors 56 into a port of the adapter 44. In the illustrated embodiment, each fiber optic adapter panel 40 and 42 can receive a total of 24 multi-fiber connectors 56 (24 adapter ports) for a total of 48 connector pairs within a 1-U space. Another embodiment, for example, may have a 1-U assembly with 72 adapter ports over the available a 1-U height requiring an adapter port-to-adapter port centerline horizontal spacing (“Y”) of 12.0 mm. (See FIG. 4). This may be accomplished when the fiber optic adapter panels 40 and 42 are connected without the use of end flanges. Additionally, having flanges just on top and bottom 50, 52 allows for multiple stacked 1-U housing structures 12.

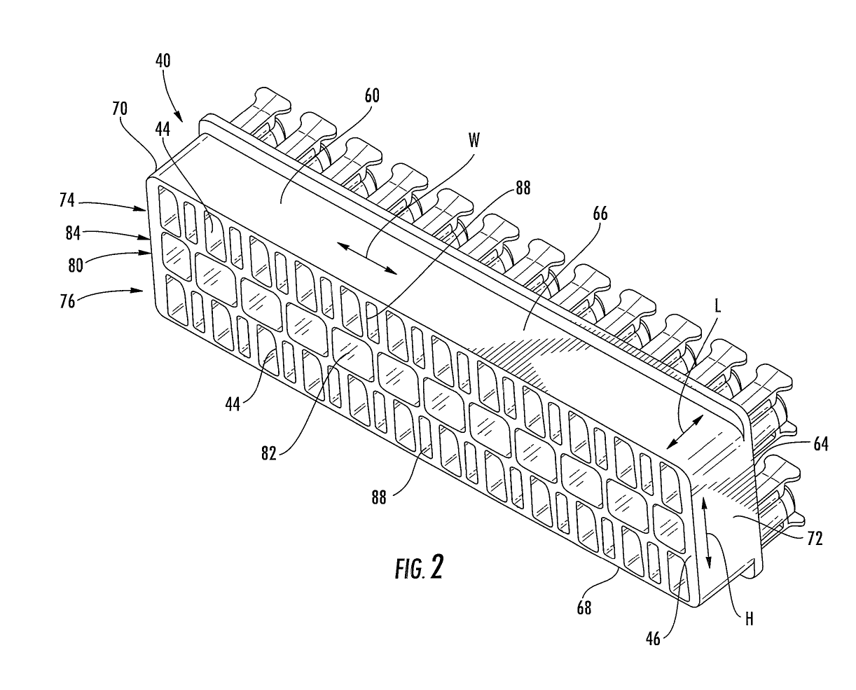

FIG. 2 illustrates the fiber optic adapter panel 40 separated from the housing structure 12 of FIG. 1. In this embodiment, the fiber optic adapter panel 40 includes a single, monolithic support body 60 that provides each of the adapters 44. The support body 12 includes the front face 46, a rear face 64, a top 66, a bottom 68 and sides 70 and 72 that extend between the front face 62 and rear face 64 in a depth or lengthwise L direction. The adapters 44 may be aligned in rows 74 and 76 that are arranged along a widthwise W direction. In the illustrated embodiment, the first row 74 includes the adapters 44 each forming the individual connector-adapter-connector locations that are spaced-apart from each other in the widthwise W direction. The adapters 44 of the first row 74 may be arranged such that centerlines of the adapters 44 are aligned in the widthwise W direction. Likewise, the second row 76 includes the adapters 44 each forming the individual connector-adapter-connector locations that are spaced-apart from each other in the widthwise W direction. The adapters 44 of the second row 76 may be arranged such that centerlines of the adapters 44 are aligned in the widthwise W direction. Adapters 44 of the first row 74 may also be aligned in a height H direction with adapters of the second row 76. The adapters 44 of the first and second rows 74 and 76 may be aligned to form adapter pairs such that centerlines of the adapter pairs are aligned in the height H direction. In embodiments having multiple stacked 1-U housing structures 12, the row-to-row dimension between the stacked housing structures 12 may be consistent with height H between rows in the same housing structure 12.

The first row 74 of adapters 44 is spaced from the second row 76 of adapters 44 in the height H direction to define a ventilation region 80 that extends in the widthwise W direction between the first and second rows 74 and 76. One or more ventilation openings 82 may be located in the ventilation region 80. In the illustrated embodiment, multiple (e.g., between two and 30, such as 12, 24, etc.) ventilation openings 82 are located in the ventilation region 80. The ventilation openings 82 may also be arranged in a row 84 such that their centerlines are aligned in the widthwise W direction. In some embodiments, one or more of the ventilation openings 82 may extend in the widthwise W direction across multiple ones of the adapter pairs. In other embodiments, one or more of the ventilation openings 82 may be located between only one of the adapter pairs.

In some embodiments, ventilation openings 88 may be located within the first and second rows 74 and 76 of adapters 44. In the illustrated example, the support body 60 includes both ventilation openings 82 located in the ventilation region 80 and ventilation openings 88 located in the rows 74 and 76. In other embodiments, the support body 60 may include only one of the ventilation openings 82 located in the ventilation region or ventilation openings 88 located in the rows 74 and 76. In this embodiment, the ventilation openings 88 are located between adjacent adapters 44 within the same row 74, 76. The ventilation openings 82, 88 with the adapter 44 port provides a “honeycomb-like” not only providing for the airflow but, also, providing strength to the adapter panel 40, 42.

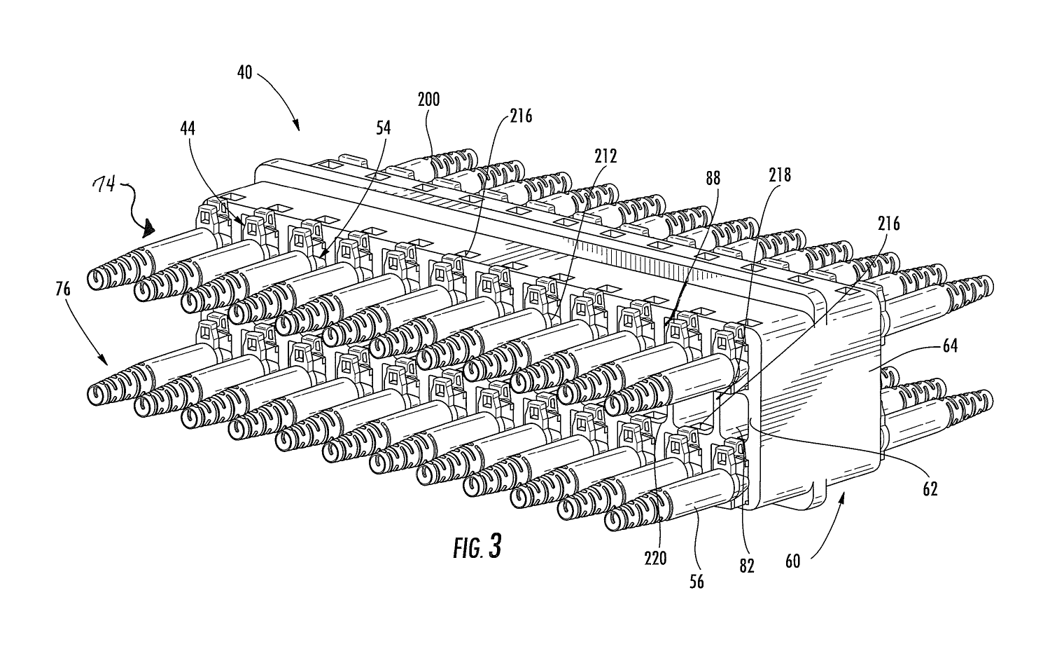

Referring to FIG. 3, the fiber optic adapter panel 40 may also receive an array of multi-fiber connectors 200 that are received by the adapters 44 through the rear face 64. In this embodiment, the multi-fiber connectors 200 may be of the same type as the multi-fiber connectors 56. In other embodiments, the multi-fiber connectors may be different (see FIG. 2). The multi-fiber connectors 200 also utilize the adapters 44 to connect with the multi-fiber connectors 56 at the individual connector-adapter-connector locations 54.

As indicated above, each adapter 44 provides an individual connector-adapter-connector location 54 where the multi-fiber connectors 56 and 200 can be optically connected together. The adapters 44 each includes an adapter port 212 for receiving a connector, on each end of the adapter 44. In this way, an adapter 44 has an adapter port 212 opening to the front face 62 and an adapter port 212 opening to the rear face 64 of the support body 60. The adapter ports 212 are sized to allow the ferrule of the multi-fiber connector 200 to engage a ferrule of the multi-fiber connector 56. The ferrules and may house one or both of optical fibers and lenses depending on the particular application. Lock ports 216 may be provided that allow the multi-fiber connectors 56 to lock in place within the adapter ports 212.

Located between the first and second rows 74 and 76 of adapters 44 are the ventilation openings 82. The ventilation openings 82 extend from the front face 62 to the rear face 64 of the support body 60 providing an unobstructed pathway through which air can enter into the housing structure 12. Partition walls 218 and 220 separate the ventilation openings 82 from the adjacent adapters 44 within a particular column. Respective partition walls 218, 220 may be consistent for ease of molding the adapter panel 40. In some embodiments, the lock ports 216 of the second row 76 of adapters 44 extend through the partition wall 220 to receive a lock tab of the multi-fiber connectors 56. Located between adjacent adapters 44 of the same row 74, 76 are the ventilation openings 88. The ventilation openings 88 also extend from the front face 62 to the rear face 64 of the support body 60 providing an unobstructed pathway through which air can enter into the housing structure 12.

Referring now to FIG. 4, a front view of the fiber optic adapter panel 40 is illustrated. As can be appreciated, with the adapters 44 occupied by the multi-fiber connectors 56 and 200 (represented by an “X”) relatively little to no air can pass through the connector receiving openings 212. The ventilation openings 82 and 88 provide unobstructed pathways through the support body 60 through which air can travel into the housing structure 12. Additionally, the ventilation openings 82, 88 may be open for maximum air flow or have a mesh covering to objects of a certain size and larger from passing through the adapter panel 40 into the housing structure 12.

In some embodiments, at least about 10 percent or more of the front face 62 of the support body 60 is open with the adapters occupied, such as about 25 percent or more, such as about 50 percent or more, such as between about 10 percent and 50 percent of open area.

The above-described multi-fiber connector assemblies include an array or set of tightly packed adapters that provide individual connector-adapter-connector locations that provide a relatively high density of connector/adapter pairs in a housing structure adapted to be mounted in a 1-U or 2-U space of an equipment rack. Even with this high connector pair density, the ventilation openings allow air to pass from outside the housing structure into the housing structure at locations between the adapters for mitigating heat build-up within the housing structure.

As used herein, the terms “fiber optic cables” and “optical fibers” include all types of single mode and multi-mode light waveguides, including one or more optical fibers that may be upcoated, colored, buffered, ribbonized or have other organizing or protective structure in a cable such as one or more tubes, strength members, jackets and the like. Likewise, other types of suitable optical fibers include bend insensitive optical fibers, or any other expedient of a medium for transmitting light signals. An example of a bend insensitive optical fiber is ClearCurve® Multimode fiber, commercially available from Corning Incorporated

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A fiber optic adapter panel for connecting optical fibers, and mountable to a housing, the adapter panel comprising:
a front face and a rear face;
an adapter region comprising a plurality of adapters extending between the front face and the rear face; and
a ventilation region having one or more openings through the adapter panel extending between the front face and the rear face, such that air passes through the one or more openings and into the housing.

2. The fiber optic adapter panel of claim 1, wherein the plurality of adapters are arranged in a first row and a second row, and wherein the first and second row of adapters are spaced-apart to define the ventilation region.

3. The fiber optic adapter panel of claim 2 comprising at least one row opening located between adjacent adapters of at least one of the first and second rows of adapters.

4. The fiber optic adapter panel of claim 2, wherein adapters of the first row are aligned with adapters of the second row to form multiple, aligned columns of adapter pairs where the adapters of each adapter pair have substantially aligned center lines.

5. The fiber optic adapter panel of claim 4, wherein the one or more openings extend widthwise across the ventilation region along multiple adapter pairs.

6. The fiber optic adapter panel of claim 5, wherein the one or more openings comprise multiple openings.

7. The fiber optic adapter panel of claim 6, wherein the multiple openings are spaced-apart widthwise within the ventilation region.

8. The fiber optic adapter panel of claim 7, wherein one of the multiple openings are located between adapters of each adapter pair.

9. The fiber optic adapter panel of claim 1, wherein the ventilation region comprises a perforation of the adapter panel extending between the front surface and the rear surface through at least one of the plurality of adapters.

10. The fiber optic adapter panel of claim 1, wherein the plurality of adapters are configured to receive a multi-fiber connector.

11. The fiber optic adapter panel of claim 1, wherein the plurality of adapters are configured to receive a MPT-type connector.

12. The fiber optic adapter panel of claim 1, wherein the fiber optic adapter panel is formed as a single, monolithic piece.

13. An assembly for connecting optical fibers, the connector assembly comprising:
a box-like housing structure adapted to mount in an equipment rack; and
a fiber optic adapter panel for connecting optical fibers mounted to the housing structure, the adapter panel comprising:
a front face and a rear face;
an adapter region comprising a plurality of adapters extending between the front face and the rear face; and
a ventilation region having one or more openings through the adapter panel extending between the front face and the rear face, such that air passes through the one or more openings and into the housing.

14. The assembly of claim 13, wherein the plurality of adapters are arranged in a first row and a second row, and wherein the first and second row of adapters are spaced-apart to define the ventilation region.

15. The assembly of claim 14 comprising at least one row opening located between adjacent adapters of at least one of the first and second rows of adapters.

16. The assembly of claim 14, wherein adapters of the first row are aligned with adapters of the second row to form multiple, aligned columns of adapter pairs where the adapters of each adapter pair have substantially aligned center lines.

17. The assembly of claim 16, wherein the one or more openings extend widthwise across the ventilation region along multiple adapter pairs.

18. The assembly of claim 17, wherein the one or more openings comprise multiple openings.

19. The assembly of claim 18, wherein the multiple openings are spaced-apart widthwise within the ventilation region.

20. The assembly of claim 19, wherein one of the multiple openings are located between adapters of each adapter pair.

21. The assembly of claim 13, wherein the ventilation region comprises a perforation of the adapter panel extending between the front surface and the rear surface through at least one of the plurality of adapters.

22. A fiber optic adapter panel for connecting optical fibers, and mountable to a housing, the adapter panel comprising:
a front face, a rear face and sides that extend lengthwise between the front and rear faces; and
a row of adapters extending between the front and rear faces with at least one row opening located between adjacent adapters of the row of adapters and extending between the front and rear faces such that air passes through the at least one row opening and into the housing.

23. The fiber optic adapter panel of claim 22, wherein the plurality of adapters are configured to receive a multi-fiber connector.

24. The fiber optic adapter panel of claim 22, wherein the plurality of adapters are configured to receive a MPT-type connector.

25. The fiber optic adapter panel of claim 22, wherein the row of adapters being a first row of adapters, the fiber optic adapter panel further comprising a second row of adapters.

26. The fiber optic adapter panel of claim 25, wherein both of the first row of adapters and the second row of adapters have row openings between adjacent adapters.

27. The fiber optic adapter panel of claim 25, wherein adapters of the first row of adapters are aligned with adapters of the second row of adapters to form multiple, aligned columns of adapter pairs where the adapters of each adapter pair have substantially aligned center lines.

28. The fiber optic adapter panel of claim 22, wherein the fiber optic adapter panel is formed as a single, monolithic piece.
